(19) United States
(12) Patent Application Publication
(10) Pub. No.: US 2017/0016847 A1
(43) Pub. Date: Jan. 19, 2017

(54) AMPEROMETRIC ELECTROCHEMICAL GAS SENSING APPARATUS AND METHOD FOR MEASURING OXIDISING GASES

(71) Applicant: ALPHASENSE LIMITED, Braintree (GB)

(72) Inventors: John SAFFELL, Cambridge (GB); Ronan BARON, Linton (GB); Marlene HOSSAIN, Stansted (GB)

(21) Appl. No.: 15/001,878

(22) Filed: Jan. 20, 2016

(30) Foreign Application Priority Data
Jul. 14, 2015 (EP) 15176730.8

(51) Int. Cl. G01N 27/407; G01N 1/22

(52) U.S. Cl. CPC G01N 27/4075; G01N 1/2205

(57) ABSTRACT

The invention relates to an amperometric electrochemical gas sensing apparatus for sensing NO₂ and O₃ in a sample gas and a method of using same. The apparatus comprises: a first working electrode which is a carbon electrode and at which both NO₂ and O₃ are reducible to thereby generate a current; a second working electrode which is a carbon electrode and at which NO₂ is reducible to thereby generate a current; and an O₃ filter material comprising 1-20% MnO₂ by weight mixed with binder and adjacent the second working electrode, and said apparatus is configured such that, in operation, the first working electrode and the O₃ filter are exposed to the sample gas in parallel.

### FIELD OF THE INVENTION

The invention relates to an amperometric electrochemical gas sensing apparatus for sensing NO₂ and O₃, and a method for sensing NO₂ and O₃ using same.

### BACKGROUND TO THE INVENTION

There is a growing demand for highly accurate air quality monitoring instruments. Particular interest lies in the monitoring of the common pollutant, NO₂. The presence of NO₂ in the atmosphere can have adverse effects on human and animal health and thus it needs to be monitored and controlled. As with most common air pollutants, NO₂ is generally present at very low concentrations, e.g. less than 5 or 10 ppb. However, NO₂ is, for example, a traffic-related pollutant and, in urban areas at peak traffic times, can be present in the atmosphere at much higher concentrations. It is desirable that air monitoring instruments are able to measure NO₂ accurately over a wide range of concentrations, in particular from 0 ppb to about 200 ppb. Interest also lies in detecting ozone, O₃ which is known to affect human health. O₃ is a secondary product of pollution and is mainly produced in the troposphere when NO₂ decomposition products react with O₂ to give O₃. Background O₃ concentrations are usually found to be about 50 ppb in urban areas. The O₃ concentration can increase or, in other cases, be depleted in the occurrence of a pollution event. Indeed, a sudden drop of O₃ can sometimes also be an indicator of the release of other pollutants such as NO in the atmosphere as O₃ is a strong oxidant agent prone to react with NO for example. It is desirable that air monitoring instruments are also able to monitor ozone over a wide range of concentrations, in particular from 0 ppb to about 200 ppb. It is particularly desirable to have an air monitoring instrument that can monitor both NO₂ and O₃ over such a range of concentrations.

The detection of NO₂ and/or O₃ attracts its own challenges. Generally, NO₂ and O₃ are co-present in the atmosphere at very low concentrations and, generally, both gases are reduced by the same electrode materials and at similar potentials. Further, other gases such as SO₂, CO, NO, NH₃ and H₂ can react at the electrodes. Thus one of the challenges of measuring NO₂ and/or O₃ accurately at low concentrations is that of dealing with interferent gases providing an electrochemical sensor response. Some embodiments address the challenge of carrying out accurate measurements of NO₂ in the presence of the potential interferent, NO. In addition, electrochemical cells are subject to a background drift issue which causes variability in response over time.

As interest grows in the environmental monitoring of NO₂ and O₃, there is a need for a highly accurate gas sensing electrochemical means for measuring same that lends itself to production on a smaller and lower cost scale. It would desirable for such means to be relatively simple in structure, simple to use, small in size (e.g. portable), amenable to mass production, robust, suitable for long term monitoring applications, and modest in cost.

Apart from O₂, the two main oxidants in the air are NO₂ and O₃. There are other oxidant gases in the ambient air such as N₂O₅, but their concentrations are not very significant (typically 1 ppb or less) in comparison with NO₂ and O₃.

The gas sensing apparatus and method of the invention overcome some or all of the above-identified problems.

### SUMMARY OF THE INVENTION

According to a first aspect of the invention, there is provided an amperometric electrochemical gas sensing apparatus for sensing NO₂ and O₃ in a gas sample, the apparatus comprising: a first working electrode which is a carbon electrode and at which both NO₂ and O₃ are reducible to thereby generate a current; a second working electrode which is a carbon electrode and at which NO₂ is reducible to thereby generate a current; and an O₃ filter adjacent the second working electrode, wherein said apparatus is configured such that, in operation, the first working electrode and the O₃ filter are exposed to the gas sample in parallel. The O₃ filter comprises a mixture of 1 to 20% by weight of MnO₂ with binder.

In the gas sensing apparatus of the invention, the first working electrode provides a measurement of both the NO₂ and O₃ present in the sample gas, the filtered second working electrode provides a measurement of the NO₂ present in the sample gas and the difference between the two measurements provides a measurement of the O₃ present in the sample gas. The gas sensing apparatus of the invention is configured so that it can be produced in a small size, for example, in a portable form.

Typically, the gas sample is air. The gas sensing apparatus of the invention can be used to provide a measurement of the amount of NO₂ and/or of O₃, for example, in the atmosphere.

The first and second working electrodes are carbon electrodes, i.e. they contain carbon as an electrode active material. The carbon of the carbon electrode may be activated carbon, amorphous carbon, graphite, graphene (the graphene may be in functionalised form, such as COOH-functionalised), glassy (or vitreous) carbon, fullerene, carbon nanotubes (including single walled, double walled and multi-walled carbon nanotubes) or boron-doped diamond (BDD) or some other suitable allotrope of carbon. It may be that the carbon of the carbon electrodes is in the form of graphite, graphene, carbon nanotubes or glassy carbon. In one embodiment the carbon is graphite. In one embodiment, the carbon is chosen from single walled or double walled carbon nanotubes. Double walled nanotubes have been found to perform similarly to single walled nanotubes. In one embodiment, carbon is the only electrode active material in the electrode. In one embodiment, carbon is the main electrode active material in the electrode, i.e. over 50 weight %, preferably over 80 weight % of the total electrode active material present in the each of the first and second working electrodes is carbon.

In one embodiment, first and second working electrodes comprise the same type of carbon. In this embodiment, they may be the same in dimension and amount of electrode active material, so that each of the first and second working electrodes provides a similar electrochemical response to NO₂. Alternatively the first working electrode can be made from a different type of carbon or have a different composition of electrode active material to that of the second working electrode.

The first working electrode is an electrode at which NO₂ and O₃ are reducible. By this is meant that NO₂ and O₃ can be reduced at the electrode. Thus, in operation, any NO₂ or O₃ reaching the first working electrode of the gas sensing apparatus of the invention will react to generate a current. The second working electrode is an electrode at which NO₂ is reducible. O₃ may also be reducible at this electrode. However, as is described later, any significant amount of ozone in the sample gas is filtered out by the ozone filter. It has been found that carbon electrodes are very specific to NO₂ and O₃ and have low cross-sensitivities for other gases, i.e. NO₂ and O₃ will oxidise at the electrodes generating current reading whereas other gases such as NO and SO₂ will not. The use of such electrodes ensures a high level of accuracy of the measurement in the gas sensing apparatus of the invention. This is particularly important for the measurement of NO₂. Thus the gas sensing apparatus of the invention can be used to provide a highly accurate measurement of the amount of NO₂ in the atmosphere, for example in urban areas where the amount of NO₂ in the atmosphere is regulated by law. The ability of the gas sensing apparatus of the invention to make a highly accurate measurement of ozone (the amount of which in the atmosphere is also regulated by law) at the same time makes the apparatus a very versatile environmental monitoring instrument.

The apparatus of the invention comprises an ozone filter. The ozone filter functions to filter ozone from the sample gas before the sample gas reaches and reacts at the second working electrode. The second working electrode has a surface and the ozone filter covers that part of the surface of the second working electrode which would otherwise be exposed to the sample gas. Preferably, the sample gas wholly passes through the ozone filter to reach the second working electrode. The ozone filter is adjacent the second working electrode, i.e. it is in close proximity to the second working electrode. The ozone filter and the second working electrode can be separated by a gas permeable structure such as a gas permeable membrane.

In one embodiment, the ozone filter is effective to filter 80 vol % percent or more, or 90 vol % or more, of the ozone from a sample gas. The ozone filter may be in powder form or in any form porous enough to allow the passage of sample gas through to the second working electrode and with a high enough surface area to ensure contact with all of the ozone present in the sample gas. The ozone filter comprises MnO₂. The MnO₂ can be in powder form. However, where the filter material is MnO₂ and there is NO present in the sample gas, the NO may react at the filter to form NO₂ and thus the NO may indirectly act as an interferent at the second working electrode. In such cases, a conventional NO sensor can be used to measure the amount of NO in the sample gas and the measurement of NO₂ in the sample gas obtained from the gas sensing apparatus of the invention can be adjusted accordingly, i.e. so that it takes into account the amount of NO₂ measured at the second electrode due to the NO present in the sample gas. Thus the measurement of NO₂ in the sample gas taken using the gas sensing apparatus of the invention is corrected based on a measurement of NO in the sample gas taken using a NO sensor. The NO sensor can be co-located with or situated close to the gas sensing apparatus of the invention. If the NO concentration in the sample gas is less than 15 ppb then this interfereing effect can be discounted.

In an embodiment, the ozone filter comprises a mixture of MnO₂, and a binder. The binder is typically particulate. The MnO₂ is typically particulate (e.g. particles of MnO₂). The binder may comprise polytetrafluoroethylene (PTFE) particles. The binder may for example, be alumina or a silicate. The MnO₂ typically has a purity of at least 90%, or at least 95%, or at least 99% or at least 99.9%. The MnO₂ may be less than 25% or less than 20% or less than 15% or less than 12% by weight of the mixture of MnO₂ and binder. The mixture of MnO₂ and binder may comprise 1 to 20% by weight of the MnO₂. Preferably, the mixture of MnO₂ and binder comprises at least 2%, or at least 5% by weight of the MnO₂. The MnO₂ may for example be 2 to 15%, or 5 to 15%, by weight of the mixture of MnO₂ and binder. The MnO₂ may be in the form of particles with a mean diameter of 25 to 250 microns. The MnO₂ may be in the form of particles with a mean diameter of 25 to 75 microns. The MnO₂ may be in the form of particles with a mean diameter of 150 to 250 microns. The binder particles may have a mean diameter of 250 to 1000 microns. The binder particles may comprise PTFE particles having a mean diameter of 700 to 1000 microns. The MnO₂ particles may coat the binder particles. By reducing the amount of MnO₂, in the ozone filter by mixing with binder we have found that NO cross-sensitivity can be reduced.

Where the ozone filter comprises a mixture of particles of MnO₂ and a particulate binder, the mixture of particles is preferably provided in a chamber which is filled with the mixture. This reduces separation of the MnO₂ particles and the binder particles.

The gas sensing apparatus of the invention is configured so that, in operation, the first working electrode is exposed to the sample gas in parallel with the ozone filter. In other words, the first working electrode and the second working electrode are effectively exposed to the sample gas at the same time, the second working electrode being exposed to the sample gas after it has passed through the ozone filter. The ozone filter is configured and positioned such that it does not cause a significant delay in the transport of the sample gas to the second working electrode. The first working electrode and the ozone filter can be described as being simultaneously in direct communication with the sample gas, i.e. the first working electrode and the ozone filter are not exposed to the sample gas in series. This can be achieved by having the first and second working electrodes positioned in close proximity or adjacent to each other. By close proximity is meant that they are both present in the same 0.5 cm³ or between 1 and 5 mm apart, for example. The gas sensing apparatus of the invention can thus be small in size and compact.

The gas sensing apparatus of the invention is an amperometric electrochemical gas sensing apparatus. In such apparatus each working electrode is associated with a counter electrode, a reference electrode and an electrolyte, i.e. the working electrode is connected conductively (electrochemically) to the counter electrode and reference electrode through the electrolyte. The counter electrode, reference electrode and electrolyte can be the same or different for each working electrode. A reduction or oxidation reaction at a working electrode generates a current between it and its counter electrode. The principle of amperometry is based on the measurement of this current. The reference electrode is used to set the operating potential of the working electrode or to bias the working electrode for best performance. The gas sensing apparatus can comprise a potentiostat circuit for this purpose. The gas sensing apparatus is preferably diffusion limited, with a diffusion barrier (such as a capillary or a porous membrane) controlling access of the sample gas to the working electrodes. The combination of electrodes operating should, in principle, have sufficient activity to maintain capillary diffusion limited behaviour. In other words the electrodes must be capable of fully consuming the capillary-limited flux of the target gas reaching it.

In one embodiment, the first and second working electrodes are associated with and share a common counter electrode, a common reference electrode and a common electrolyte. In other words, the gas sensing apparatus of the first aspect of the invention further comprises one counter electrode, one reference electrode, and one body of electrolyte, with the first, second, counter and reference electrodes being in electrochemical contact with each other through said body of electrolyte. In this embodiment of the invention, a particularly compact gas sensing apparatus is achievable, due to the relatively small number of components.

In another embodiment, the first and second working electrodes do not share common counter and reference electrodes, or a common electrolyte. Each of the first and second electrodes is associated with its own counter electrode, reference electrode and electrolyte. In this embodiment the gas sensing apparatus of the first aspect of the invention further comprises a first counter electrode, a first reference electrode, a first body of electrolyte and a second counter electrode, a second reference electrode and a second body of electrolyte. In this embodiment, each of first working, counter and reference electrodes are in electrochemical contact with each other through the first body of electrolyte and each of second working, counter and reference electrodes are in electrochemical contact with each other through the second body of electrolyte. In this embodiment of the invention, the gas sensing apparatus can comprise two individual gas sensors, one of which has first working, reference and counter electrodes and a first electrolyte, the other having second working, reference and counter electrodes, a second electrolyte and an ozone filter adjacent the second working electrode. The sensors can be identical, except for the presence of the ozone filter in one of them. The sensors can be situated and coupled to each other on the same circuit board.

The reference and counter electrodes used in the gas sensing apparatus of the invention can be made of various electrode active materials which include carbon, gold, gold alloys, Pt, and Pt alloys. The platinum can be in the form of platinum oxide which includes platinum black (Ptb) and the gold can be in the form of gold oxide which includes gold black. The carbon and a carbon electrode are as described above for the first and second working electrodes. The counter electrodes can be the same or different from the reference electrodes. In one embodiment, the first, second or common reference electrode is chosen from carbon, gold, gold alloy, Pt, and Pt alloy electrodes and the first second or common counter electrode is the same as or different from the respective first, second or common reference electrode. In one embodiment, the first, second or common reference electrode is chosen from carbon, gold, gold alloy, Pt, and Pt alloy electrodes and the first second or common counter electrode is a Ptb electrode. Other combinations of reference and counter electrodes include: carbon reference electrode and platinum black counter electrode; and gold reference electrode and platinum black or gold counter electrode.

In one embodiment, each of the first and second working electrodes has an additional working electrode associated with it, the additional working electrode being incorporated in the gas sensing apparatus such that it is not exposed to the sample gas. The additional electrode is buried within the sensor body and is used to generate a signal for correcting the working electrode baseline for background signal drift due to, for example, temperature. This ability to correct the baseline signal of the working electrode for background drift means that the measurements of the gas sensing apparatus are highly accurate. This is particularly important when measuring low concentrations of NO₂ and O₃.

The additional working electrode can be made of various electrode active materials which include carbon, gold, gold alloys, Pt alloys and platinum. The platinum can be in the form of platinum oxide which includes platinum black (Ptb) and the gold can be in the form of gold oxide which includes gold black. The carbon and a carbon electrode are as described above for the first and second working electrodes. In one embodiment, the additional working electrode is a carbon electrode.

Thus in one embodiment the first and second working electrodes are associated with and share a common counter electrode, a common reference electrode, a common additional electrode for correcting baseline drift and a common electrolyte. In another embodiment the first working electrode is associated with a first counter electrode, a first reference electrode, a first additional electrode for correcting baseline drift and a first electrolyte and the second working electrode is associated with a second counter electrode, a second reference electrode, a second additional electrode for correcting baseline drift and a second electrolyte.

The electrolyte is typically a liquid electrolyte, for example, diluted H₂SO₄ (5 M). Other standard electrolytes used in amperometric sensors include diluted H₃PO₄ and tetraalkyl ammonium salts dissolved in propylene carbonate. Typically, the first electrolyte, second electrolyte or a common electrolyte (as appropriate) are chosen from H₂SO₄. propylene carbonate and tetraethylammonium fluoride or H₃PO₄

The apparatus of the invention can contain control circuits that can switch or activate/deactivate the electrodes and/or a processor for processing the current signals from the electrodes to thereby determine a concentration of NO₂ and/or O₃ gas.

A second aspect of the invention relates to a method for sensing NO₂ and O₃ gas in a sample gas comprising: (1) exposing a sample gas to a first working electrode and an O₃ filter adjacent a second working electrode in parallel, wherein the O₃ filter comprises a mixture of 1 to 20% by weight of MnO₂ and binder, said first working electrode is a carbon electrode at which NO₂ and O₃ are reducible to thereby generate a current and said second working electrode is a carbon electrode at which NO₂ is reducible to thereby generate a current; and (2) determining the presence of NO₂ and O₃ gas in said sample gas by a reading of the currents generated by the first and second working electrodes, respectively.

The current readings generated can be calibrated using means known in the art, thus providing a measurement of the concentration of NO₂ and O₃ gas in a sample gas.

In the second aspect of the invention, the method comprises using the gas sensing apparatus of the invention as described herein.

The method of the invention can be used to provide an accurate indication of the amount presence of NO₂ and O₃ in a sample gas, such as air, and is particularly useful in applications where an accurate determination is essential for health and safety reasons. In particular, the method of the invention provides a very accurate indication of NO₂.

### BRIEF DESCRIPTION OF THE FIGURES

FIG. 1 is a schematic cross-sectional view of a gas sensing apparatus of the invention according to an embodiment wherein the first and second working electrodes share a common counter electrode, reference electrode and electrolyte.

FIG. 2 relates to a gas sensing apparatus of the invention according to an embodiment comprising two individual electrochemical amperometric gas sensors one housing the first working electrode and its associated counter electrode, reference electrode, electrolyte and additional working electrode, the other housing an ozone filter, the second working electrode and its associated counter electrode, reference electrode, electrolyte and additional working electrode. FIG. 2 provides a schematic cross-sectional view of each of these sensors.

FIG. 3 is a diagram of potentiostatic circuitry for a gas sensing apparatus in which first and second working electrodes share a common counter electrode, reference electrode and electrolyte as for example, in the embodiment of FIG. 1 or in which a working electrode and an additional working electrode share a common counter electrode, reference electrode and electrolyte as for example, in one of the individual gas sensors of the embodiment of FIG. 2.

FIG. 4 is a graph of current generated versus time for (a) a sensor according to FIG. 2(2) with a filter of 25 mg MnO₂, 99.9% purity, mixed with 225 mg PTFE, i.e. 10% by weight of MnO₂ and (b) a sensor according to FIG. 2(1) (no filter), while the sensors are exposed in turn to air without NO₂ or O₃, then 2 ppm NO₂, 2 ppm O₃ and then a mixture of 2 ppm NO₂ and 2 ppm O₃.

FIG. 5 is a calibration curve showing the output current for a sensor according to FIG. 2) with a filter of 25 mg MnO₂, 99.9% purity, mixed with 225 mg PTFE, i.e. 10% by weight of MnO₂ at different concentrations of NO₂.

FIG. 6 illustrates cross sensitivity to NO over time since construction for (a) a sensor according to FIG. 2(2) with a filter of 450 mg MnO₂, 99.9% purity, i.e. 100% by weight of MnO₂, and (b) a sensor according to FIG. 2(2) with a filter of 25 mg MnO₂, 99.9% purity, mixed with 225 mg PTFE, i.e. 10% by weight of MnO₂.

FIG. 7 shows the current response to 0.5 ppm O₃ of (a) an unfiltered sensor according to FIG. 2(1), and (b) a sensor according to FIG. 2(2) with a filter of 25 mg MnO₂, 99.9% purity, mixed with 225 mg PTFE, i.e. 10% by weight of MnO₂, 170 days after construction of the sensors.

FIG. 8 shows the current response to NO₂ of a sensor according to FIG. 2(2) with a filter of 25 mg MnO₂, 99.9% purity, mixed with 22 5mg PTFE, i.e. 10% by weight of MnO₂, 170 days after construction of the sensor.

FIG. 9 is a photograph of PTFE particles (sieved to have a size of at least 700 microns) coated with MnO₂ crystals, 99.9% purity.

### DETAILED DESCRIPTION OF EXAMPLE EMBODIMENTS

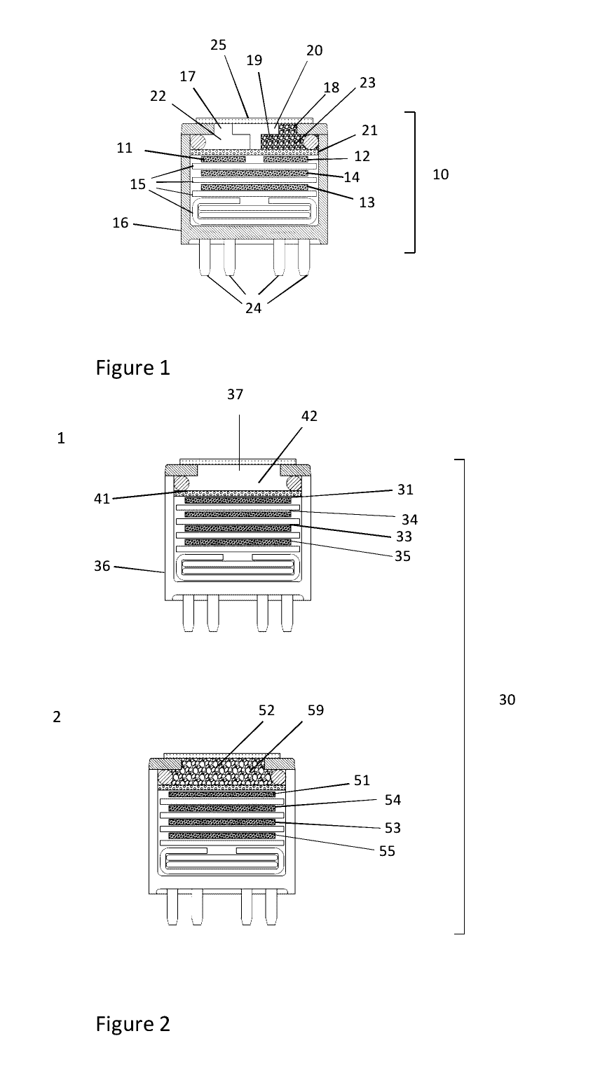

FIG. 1 is a schematic cross-sectional view of a gas sensing apparatus (10) in which the first (11) and second (12) working electrodes share a common counter electrode (13), a common reference electrode (14) and a common body or reservoir of electrolyte, mainly held in wetting filters (15).

The gas sensing apparatus comprises a housing (16) which has two inlets (17) and (18), which place the first working electrode (11) and the O₃ filter (19) in direct communication with the sample gas (e.g. the atmosphere) in parallel. Inlets (17) and (18) can be capillary inlets, i.e. inlets which are sized so that they control the rate of sample gas reaching the electrodes so that the gas sensing apparatus is diffusion limited, A central portion (20) divides a cavity defined by the housing (16) and a porous membrane (21) into first (22) and second (23) internal chambers. The first and second working electrodes are located in the same horizontal plane and are situated underneath the porous membrane (21). The first working electrode (11) is situated underneath the first internal chamber (22) and the second working electrode (12) is situated underneath the second internal chamber (23). The ozone filter (19) is located in the second internal chamber (23), adjacent/on top of part of the porous membrane (21) covering the second working electrode (12). The ozone filter (19) covers the surface of the second working electrode (12) that would, absent the filter, be exposed to the sample gas. A series of circular separator discs, wicks or wetting filters (15) separate the first (11) and second (12) working electrodes from the counter electrode (13) and the reference electrode (14).

The circular separator discs, wicks or wetting filters (15) are made of a hydrophilic, non-conductive material permeable to the electrolyte which functions to transport electrolyte by capillary action. Typically the material is glass fiber. The circular separator discs, wicks or wetting filters (15) serve to ensure that each of the electrodes is in contact with the electrolyte.

The first and second working electrodes are carbon electrodes and typically comprise a catalytic layer of carbon mixed with polytetrafluoroethylene (PTFE) binder which is then bonded to a gas porous, but hydrophobic, PTFE support to allow gas support to the catalyst, i.e. the electrode active material, but avoid electrolyte leakage or flooding of the electrode. The carbon electrodes can be manufactured using common conventional technologies such as pressing, screen printing, inkjeting and spraying a carbon slurry onto a porous membrane. Here the working electrode catalyst will typically have a diameter of 19 mm. A mixture of carbon and microparticulate polytetrafluoroethylene (PTFE) is sintered and is preferably prepared by pressing the resulting mixture onto a support in the form of a gas porous membrane, such as PTFE sheet. Where carbon is pressed at the normal pressure used in the field, i.e. around 200 kg/cm², the amount of catalyst is preferably between 5 and 30 mg per cm² of electrode surface area. Preferably the binder is a Fluon matrix (Fluon is a Trade Mark) of around 0.002 ml per cm². Other electrodes used in the gas sensing apparatus of the invention, such as the Platinum black electrodes can be prepared in a similar way.

An O ring is located at the top of the porous membrane (21) and acts to seal the sensor and to aid compressing the stack of components when the sensor is sealed. Also present are a number of platinum strips that serve to connect each electrode to one of the terminal pins (24) provided at the base of the sensor. Closing housing is a dust filter (25) to prevent dust and other foreign objects from entering.

FIG. 2 provides schematic cross-sectional views of two individual gas sensors, each having its own working electrode, counter electrode, reference electrode, additional electrode and electrolyte. Together, these form a gas sensing apparatus (30) according to the invention. These gas sensors have similar stacked structures.

FIG. 2(1) shows a gas sensor with first working electrode (31) and its associated counter electrode (33), reference electrode (34), electrolyte and additional working electrode (35) for correcting for baseline drift. An internal chamber (42) is defined by the housing (36) and a porous membrane (41). Housing (36) has one inlet (37) which places the first working electrode (31) in direct communication with the sample gas (e.g. the atmosphere).

FIG. 2(2) shows a gas sensor of similar construction except for the presence of an ozone filter (59) in the internal chamber (52) above the second working electrode (51). The second counter electrode (53), second reference electrode (54), electrolyte and second additional working electrode (55) for correcting for baseline drift are labelled on the figure.

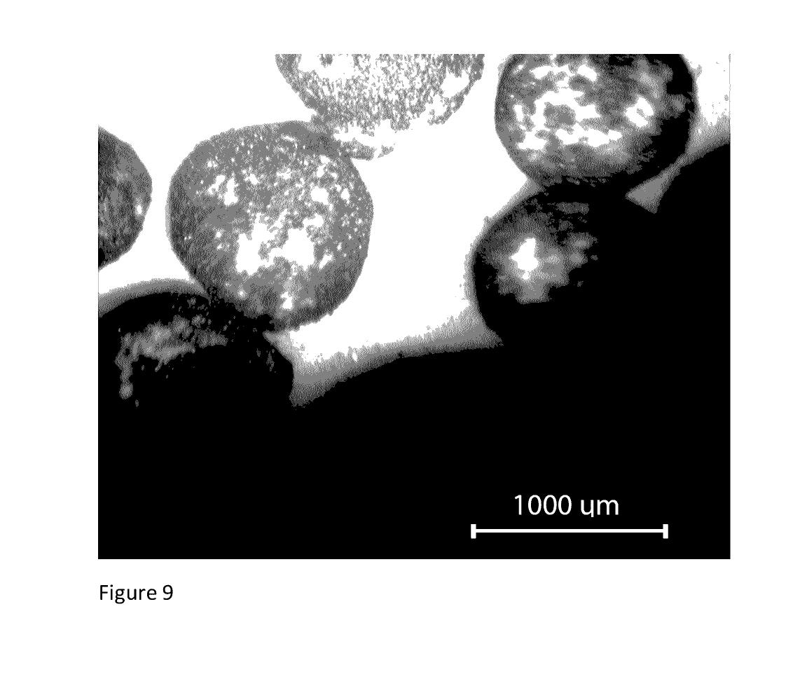

In an example, the filter was made up from 10% by weight of Manganese (IV) oxide, >99.9% purity, approx. 325 mesh (44 micron) powder (Product No. 42250 from Alpha Aesar), mixed with 90% by weight of PTFE binder particles, with a particle size of 700 to 1000 microns. The PTFE binder particles were obtained by sieving Fluon PTFE G307 (Fluon is a trade mark) median particle size 500 to 1000 microns, to collect only particles with a size of at least 700 microns. FIG. 9 is a photograph of the coated particles. BET analysis of the MnO₂ gave a result of 2.08 m²/g.

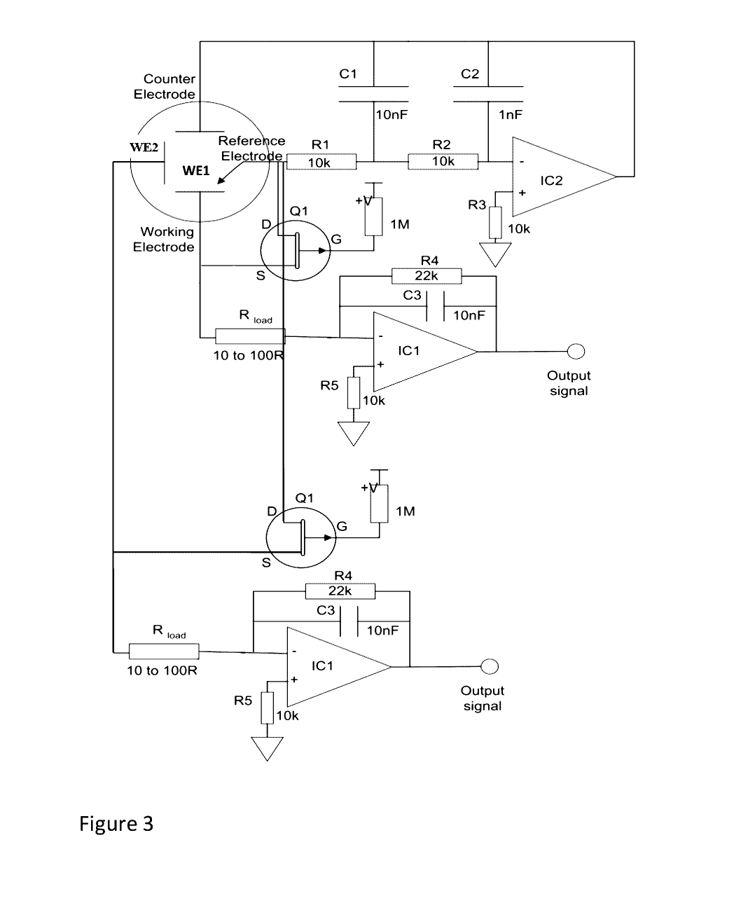

Example circuitry for the gas sensing apparatus of the invention in the embodiment of FIG. 1 is shown in FIG. 3, where WE1 is the first working electrode and WE2 is the second working electrode. This circuitry could also be used for either of the individual sensors making up the gas sensing apparatus of the invention in the embodiment of FIG. 2, where, for example, WE1 is the first working electrode and WE2 is the first additional working electrode, or WE1 is the second working electrode and WE2 is the second additional working electrode.

### Experimental Section

The sensors used in the following examples were tested on standard potentiostatic circuit boards (FIG. 3). Generally, the sensors were stabilised for a minimum of 2 days before being tested. All the experiments involving gas tests were controlled using computer controlled valves and digital mass flow controllers. Sensor output data collection is also made using a computer. The NO₂ gas tests were made using a certified 100 ppm bottle (Air Products, UK) and filtered air. The ozone was obtained using a calibrated generator (Ultra-violet Products Ltd, SOG-1, Cambridge, UK). During the laboratory tests the sensors were exposed to a gas flow of 0.51.min⁻¹.

The following material was used as filter powder: MnO₂ powder, purchased from Alpha Aesar, approx. 325 mesh size (i.e. a particle size of about 44 microns), analytical grade 99.9%), product code 310700.

Materials used to make the electrodes include carbon graphite (particle size <20 μm, Aldrich, product code 282863), high purity single-walled carbon nanotubes, graphene (Graphene GNP COOH-functionalised, Gwent Electronic Materials Ltd), glassy carbon (Carbon, glassy, spherical powder, 2-12 micron, 99.95%, Aldrich, product code 484164).

Calibration of the sensors according to the invention was carried out as follows. The sensor output is given in nA. Amperometric gas sensors have a linear output with target gas analyte concentration. This makes possible to use a simple calibration procedure where the relation between the sensor output and the gas concentration is determined by exposing the sensor to a known concentration of gas analyte. For this application the sensitivity to both the first and the second working electrodes is determined for each of the target gases, NO₂ and O₃. The sensor output can then be used to calculate the concentration of NO₂ and O₃.

If the following parameters are defined as follows:
i₁ is the current observed on the first working electrode.
I₂ is the current observed on the second working electrode.
S_{1(NO2)} is the first working electrode sensitivity to NO₂.
S_{1(O3)} is the first working electrode sensitivity to O₃.
S_{2(NO2)} is the second working electrode sensitivity to NO₂.
S_{2(O3)} is the second working electrode sensitivity to O₃.
C_{(NO2)} is the NO₂ analyte concentration to determine.
C_{(O3)} is the O₃ analyte concentration to determine. Then, by definition and taking into account the linear relationship between the sensor output and the analyte concentration, the following can be written:

i₁=S_{1(NO2)}·C_{(NO2)}+S_{1(O3)}·C_{(O3)}

i₂=S_{2(NO2)}·C_{(NO2)}+S_{2(O3)}·C_{(O3)}

The ozone filter on top of the second working electrode means that S_{2(O3)}=0. So C_{(NO2)} can be calculated using the simple relation:

C_{(NO2)}=i₂/S_{2(NO2)}

The NO₂ analyte concentration being now known it is then possible to calculate the O₃ analyte concentration using the first working electrode output:

C_{(O3)}=(i₁−S_{1(NO2)}·C_{(NO2)})/S_{1(O3)}

or

C_{(O3)}=(i₁−S_{1(NO2)}·(i₂/S_{2(NO2)}))/S_{1(O3)}

### Experiment 1

In this example, a sensor according to FIG. 2(1) (no filter) and a sensor according to FIG. 2(2) in which the filter (59) in the chamber (52) was formed with 25 mg of particulate MnO₂, 99.9% purity, mixed with 225 mg PTFE, i.e. 10% by weight of MnO₂. The PTFE was in the form of particles with a size of about 750 microns. The unfiltered sensor is commercially available under the trade name OX-A421, manufactured and sold by Alphasense Limited of Great Dunmow. For these sensors the first working electrode, the second working electrode, the additional electrode and the reference electrode are made of carbon graphite and the counter electrode is made of platinum black.

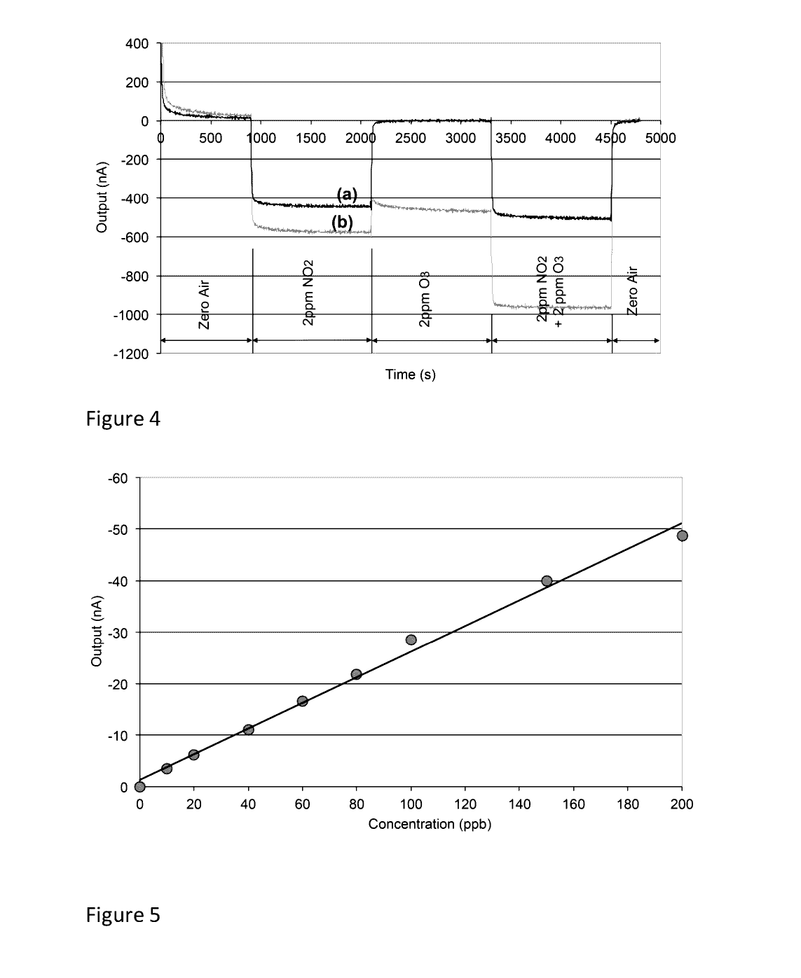

FIG. 4 illustrates the output current, over time, where the unfiltered sensor (trace (a)) and filtered sensor (trace (b)) are exposed in turn to zero air (zero air is air that has been filtered to remove most gases (NO₂, NO, CO, SO₂, O₃, etc.) and is used as a calibrating gas for zero concentration), then 2 ppm NO₂, 2 ppm O₃ and then a mixture of 2 ppm NO₂ and 2 ppm O₃. This figure shows that the filtered sensor senses only NO₂, whereas the unfiltered sensor detects both gases and, when in the presence of both gases simultaneously, the output of the sensor corresponds to the sum of the output expected for each of the gases.

### Experiment 2

Filtered sensors as described above for experiment 1 were exposed to each of NO, SO₂, CO, H₂, CO₂ and NH₃, at the concentration specified in Table 1 below, for 10 minutes. These gases are the most common possible interferents in the air. In this experiment, the cross sensitivity values for the sensors are determined (the values given in % relative to the signal obtained for NO₂). The results are listed in Table 1.

TABLE 1

| | Gas | | | | | |
|---|---|---|---|---|---|---|
| | NO | SO₂ | CO | H₂ | CO₂ | NH₃ |
| Gas concentration (ppm) | 5 | 5 | 5 | 100 | 50000 | 20 |
| Cross-sensitivity (%) | 3 | 1 | 0.5 | 0.1 | 0 | 0.05 |

The set of data obtained shows that the unfiltered sensors are highly specific to NO₂ and O₃.

Hence in a complex environment where these different gases are present, the unfiltered sensor will give an output representative of the sum of the concentration of NO₂ and O₃.

### Experiment 3

The response of a filtered sensor as described above with reference to Experiment 1, having a filter of 25 mg MnO₂, 99.9% purity, mixed with 225 mg PTFE, to NO₂ was measured across a range of 0 to 200 ppb NO₂. FIG. 5 shows that there is a good linearity of output current versus NO₂ concentration even at the low concentrations used.

### Experiment 4

Cross sensitivity to NO (i.e. the ratio of the current generated when a sensor is exposed to NO to the current generated when a sensor is exposed to a corresponding concentration of NO₂ is an important performance characteristic of an NO₂ sensor.

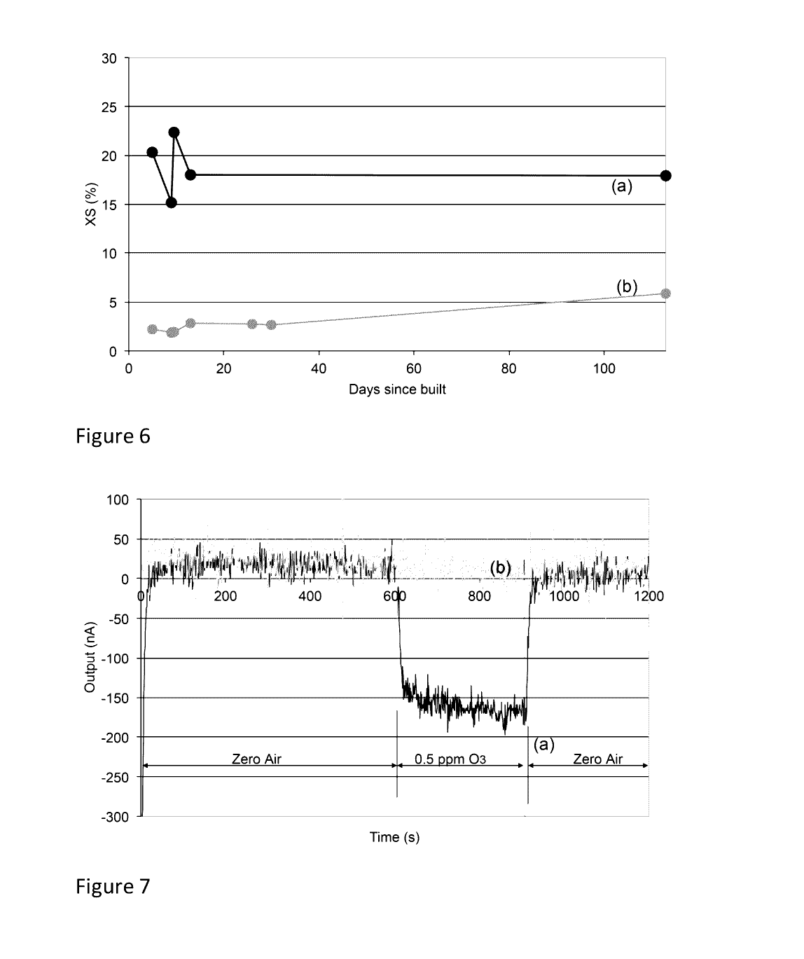

FIG. 6 illustrates cross sensitivity to NO over time since construction for (a) a sensor according to FIG. 2(2) with a filter of 450 mg MnO₂, 99.9% purity, i.e. 100% by weight of MnO₂, and (b) a sensor according to FIG. 2(2) with a filter of 25 mg MnO₂, 99.9% purity, mixed with 225 mg PTFE, i.e. 10% by weight of MnO₂. The cross sensitivity was calculated by measuring the current at 2 ppm NO and 2 ppm NO₂ and calculating the ratio of the currents.

It can be seen that the NO cross-sensitivity is significantly lower when the filter uses MnO₂ powder which has been diluted in binder, in this case PTFE, then when pure MnO₂ is used as the filter. We have found that if the filter is diluted to as low as 1% by weight of MnO₂, the quality of the signal drops off. However, from about 2% upwards to about 15% gives good results.

### Experiment 5

FIG. 7 shows the current response to 0.5 ppm O₃ of (a) an unfiltered sensor according to FIG. 2(1), and (b) a sensor according to FIG. 2(2) with a filter of 25 mg MnO₂, 99.9% purity, mixed with 225 mg PTFE, i.e. 10% by weight of MnO₂, 170 days after construction of the sensors.

This figure shows that the filtered sensor with 10% by weight of MnO₂ gives a lasting ozone filtering effect—there is no response at all to ozone for a 170 day old sensor.

### Experiment 6

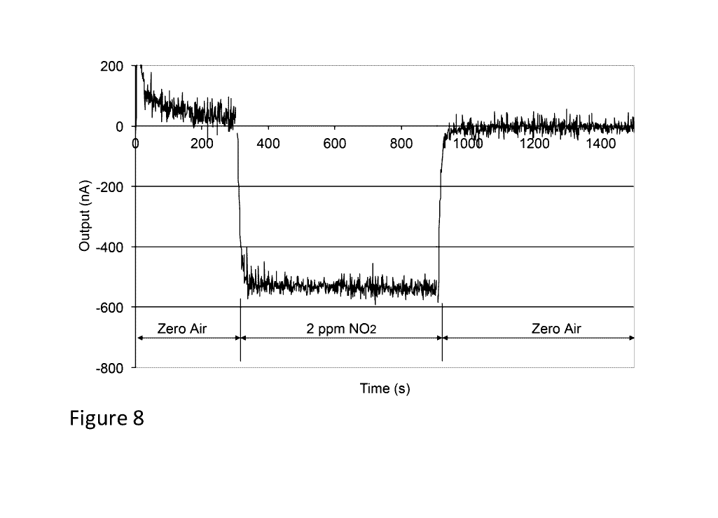

FIG. 8 shows the current response to NO₂ of a sensor according to FIG. 2(2) with a filter of 25 mg MnO₂, 99.9% purity, mixed with 225 mg PTFE, i.e. 10% by weight of MnO₂, 170 days after construction of the sensor.

These results show that the sensor continues to let NO₂ through and so can be used to measure NO₂, while scrubbing O₃, after an extended period of time.

### Conclusions

We have found that providing sensing apparatus having a first unfiltered carbon electrode and a second carbon electrode having an ozone filter comprising MnO₂ particles diluted in binder provides a stable sensor capable of discriminating between NO₂ and O₃ and therefore of measuring either or both, and having a low cross-sensitivity to NO.

We have also found it preferable for the amount of PTFE microparticles to be sufficient to fill the internal chamber (42) of the sensor. If the internal chamber was only partially filled with a filter powder, there would be a risk that the powder could move when the sensor is moved, possibly opening a pathway for the gas directly to the electrode without passing through the filter material. PTFE microparticles have the advantage of easily becoming coated with the MnO₂ microparticles and the mixing results in a well homogeneous PTFE microparticles/MnO₂ microparticles filter material.

What is claimed is:

1. Amperometric electrochemical gas sensing apparatus for sensing NO₂ and O₃ in a sample gas, the apparatus comprising:
a first working electrode which is a carbon electrode and at which both NO₂ and O₃ are reducible to thereby generate a current;
a second working electrode which is a carbon electrode and at which NO₂ is reducible to thereby generate a current; and
an O₃ filter adjacent the second working electrode,
wherein said apparatus is configured such that, in operation, the first working electrode and the O₃ filter are exposed to the sample gas in parallel, and wherein the O₃ filter comprises a mixture of 1 to 20% by weight of MnO₂, and binder.

2. Amperometric electrochemical gas sensing apparatus according to claim 1 wherein the binder is particulate.

3. Amperometric electrochemical gas sensing apparatus according to claim 2 wherein the binder is particulate polytetrafluoroethylene.

4. Amperometric electrochemical gas sensing apparatus according to claim 1 wherein the MnO₂ comprises particles with a purity of at least 98%.

5. Amperometric electrochemical gas sensing apparatus according to claim 1 wherein the first and second electrodes are the same or different.

6. Amperometric electrochemical gas sensing apparatus according to claim 5 wherein the carbon of the carbon electrodes is in the form of activated carbon, amorphous carbon, graphite, fullerene, graphene, glassy carbon, carbon nanotubes, or boron-doped diamond.

7. Amperometric electrochemical gas sensing apparatus according to claim 1 wherein the first working electrode is associated with a first counter electrode, a first reference electrode and a first electrolyte, and the second working electrode is associated with a second counter electrode, a second reference electrode and a second electrolyte.

8. Amperometric electrochemical gas sensing apparatus according to claim 1 wherein the first and second working electrodes are associated with a common counter electrode, a common reference electrode and a common electrolyte, and optionally a common additional working electrode, which common additional working electrode may, if present, be chosen from carbon, gold, gold alloy, Pt alloy or platinum electrodes

9. Amperometric electrochemical gas sensing apparatus according to claim 1, wherein each of the first and second working electrodes has an additional working electrode associated with it, the additional working electrode being situated in the apparatus such that it is not exposed to the sample gas.

10. Amperometric electrochemical gas sensing apparatus according to claim 7 comprising first and second additional working electrodes, associated with the first and second working electrodes, respectively.

11. Amperometric electrochemical gas sensing apparatus according to claim 10 wherein the first and second additional working electrodes are the same or different and are chosen from carbon, gold, gold alloy, Pt alloy or platinum electrodes.

12. Amperometric electrochemical gas sensing apparatus according to claim 7 wherein: the first, and second reference electrodes are the same or different and are chosen from carbon, gold, gold alloy, Pt or Pt alloy, the first and second counter electrodes are the same or different: and the first, second and common reference electrodes and are chosen from carbon, gold, gold alloy, Pt alloy or platinum electrodes.

13. Amperometric electrochemical gas sensing apparatus according to claim 9 comprising first and second additional working electrodes, associated with the first and second working electrodes, respectively.

14. Amperometric electrochemical gas sensing apparatus according to claim 13 wherein the first and second additional working electrodes are the same or different and are chosen from carbon, gold, gold alloy, Pt alloy or platinum electrodes.

15. Amperometric electrochemical gas sensing apparatus according to claim 10 wherein: the first, and second reference electrodes are the same or different and are chosen from carbon, gold, gold alloy, Pt or Pt alloy, the first and second counter electrodes are the same or different: and the first, second and common reference electrodes and are chosen from carbon, gold, gold alloy, Pt alloy or platinum electrodes.

16. Amperometric electrochemical gas sensing apparatus according to claim 8 wherein the common reference electrode and the common counter electrode are the same or different and are chosen from carbon, gold, gold alloy, Pt alloy or platinum electrodes.

17. A method for sensing NO₂ and O₃ gas in a sample gas comprising:
exposing a sample gas to a first working electrode and an O₃ filter adjacent a second working electrode in parallel, wherein the first working electrodes is a carbon electrode at which both NO₂ and O₃ are reducible to thereby generate a current, the second working electrode is a carbon electrode at which NO₂ is reducible to thereby generate a current, and the O₃ filter comprises a mixture of 1 to 20% by weight of MnO₂, and binder, and determining the presence of NO₂ and O₃ in said sample gas by a reading of the currents generated by the first and second working electrodes, respectively.

18. A method according to claim 17, wherein the binder is particulate polytetrafluoroethylene.

19. A method according to claim 17, wherein the MnO₂ comprises particles with a purity of at least 98%.

20. A method according to claim 17, where the MnO₂ is particulate, the particles having a mean diameter of 25 to 250 microns.
